(19) United States
(12) Patent Application Publication
(10) Pub. No.: US 2016/0212985 A1
(43) Pub. Date: Jul. 28, 2016

(54) DUCK DECOY WITH ACTUATING WINGS

(71) Applicant: Ricky Fredrick BULLINGTON, Camden, TN (US)

(72) Inventor: Ricky Fredrick BULLINGTON, Camden, TN (US)

(21) Appl. No.: 14/607,380

(22) Filed: Jan. 28, 2015

(51) Int. Cl. A01M 31/06; A01M 31/00

(52) U.S. Cl. CPC A01M 31/06; A01M 31/00

(57) ABSTRACT

An actuating duck decoy is provided. The duck decoy includes a body in the shape of a duck. The body includes an outer surface with a first side, a second side, a top, a bottom, a front and a rear. The body further includes an internal housing. The present invention further includes a first wing pivotally attached to the first side of the body and a second wing pivotally attached to the second side of the body. A motor powered by a power source may is housed within the internal housing of the body. The motor drives a rotating axle. A first actuating bracket connects the bottom of the first wing to the axle and a second actuating bracket connects the bottom of the second wing to the axle. The motor and the first and second actuating brackets are operable to pivot the first wing and the second wing along an axis running from the front to the rear of the body. Therefore, the motor pivots the wings up and down from the top to the bottom.

### BACKGROUND OF THE INVENTION

The present invention relates to a duck decoy and, more particularly, to a duck decoy with actuating wings.

A duck decoy is a man-made object resembling a real duck. Duck decoys are sometimes used in duck hunting to attract real ducks. Duck decoys were historically carved from wood or cork, but modern ones are also made of canvas and plastic. They are usually painted, often elaborately and very accurately, to resemble various kinds of waterfowl. Current duck decoys do not include moving parts, or if they do include moving parts, the duck decoy is weak and does not provide realistic movements.

As can be seen, there is a need for an improved duck decoy with moving parts and actuating wings.

### SUMMARY OF THE INVENTION

In one aspect of the present invention, an actuating duck decoy comprises: a body in the shape of a duck comprising an outer surface comprising a first side, a second side, a top, a bottom, a front and a rear, and an internal housing; a first wing pivotally attached to the first side of the body and a second wing pivotally attached to the second side of the body; a motor comprising a power source, wherein the motor is within the internal housing and comprises a rotating axle; and a first actuating bracket connecting the first wing to the axle, and a second actuating bracket connecting the second wing to the axle, wherein the motor and the first and second actuating brackets are operable to pivot the first wing and the second wing along an axis running from the front to the rear of the body.

These and other features, aspects and advantages of the present invention will become better understood with reference to the following drawings, description and claims.

### BRIEF DESCRIPTION OF THE DRAWINGS

FIG. 1 is a perspective view of the present invention shown in exemplary primary state;

FIG. 2 is a perspective view of the present invention shown in exemplary secondary state;

FIG. 3 is a perspective view of the present invention shown in exemplary tertiary state;

FIG. 4 is a detail perspective view of the present invention shown in exemplary primary state;

FIG. 5 is a detail perspective view of the present invention shown in exemplary secondary state;

FIG. 6 is a detail perspective view of the present invention shown in exemplary tertiary state;

FIG. 7 is an exploded detail view of mechanical operational components of the present invention;

FIG. 8 is a section detail view of the present invention along line 8-8 in FIG. 4;

FIG. 9 is a section detail view of the present invention demonstrated in exemplary secondary state relative to FIG. 8; and

FIG. 10 is a top perspective detail view of the present invention demonstrated with the lid shown in raised configuration exposing inner components.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a mechanical design duck decoy to attract game. The location of the wings of the present invention has been changed as compared to the prior art by two mounting brackets so the wings may be lowered on each side of the lower shell giving the wings a higher lift at the wing tips. Mounting brackets are designed and attached to the lower shell to cause the wing tips to lift higher than existing wings which makes the product more attractive to game. The wings may be shorter than the prior art to improve battery life, but the overall the wing span is the same because of the location of the mounting brackets.

The mounting brackets secure the wings to the lower shell of the body of the present invention. The rotating couplings attach the motor axle to the rotating angled ball rod. The fastener pivoting cups are mounted to the wings. A DC motor may drive the rotating couplings, which is locked to the motor axle. This angled ball rods are eccentric or off set. The offset linkage which is hooked to the mounting bracket provides a different angle that looks more attractive to game in the field. The fastening cups attach to the wings. The mounting brackets are stationary which holds the end of the wings to the body.

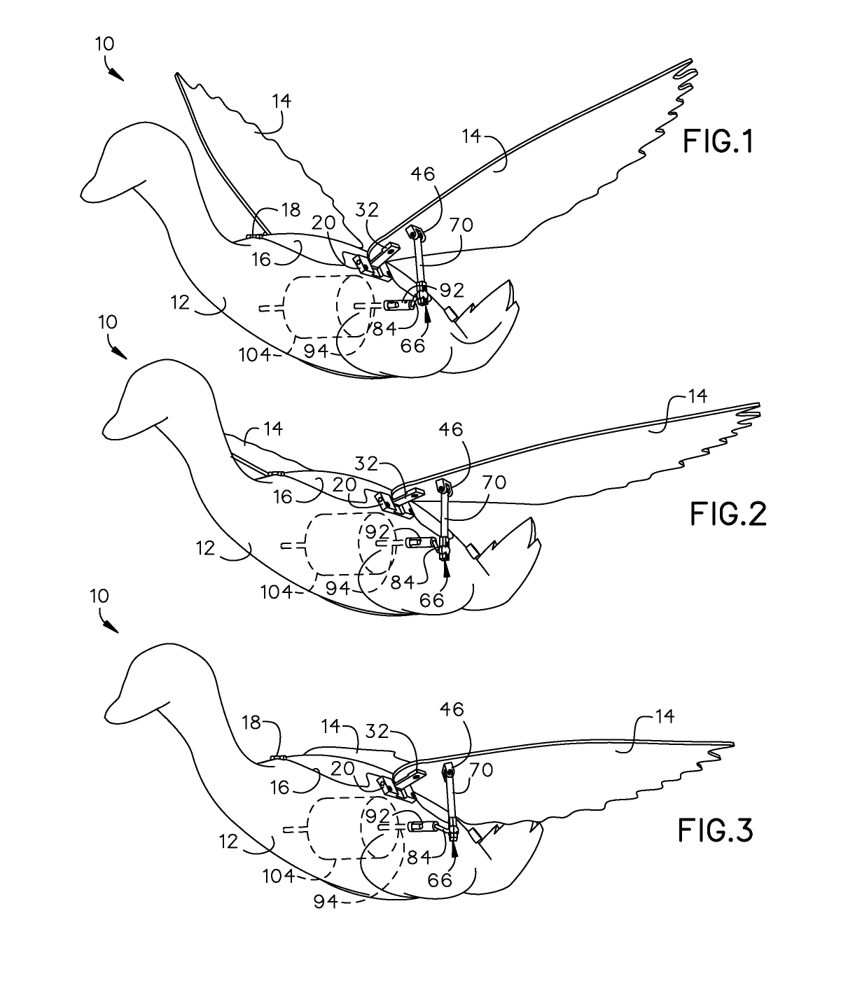

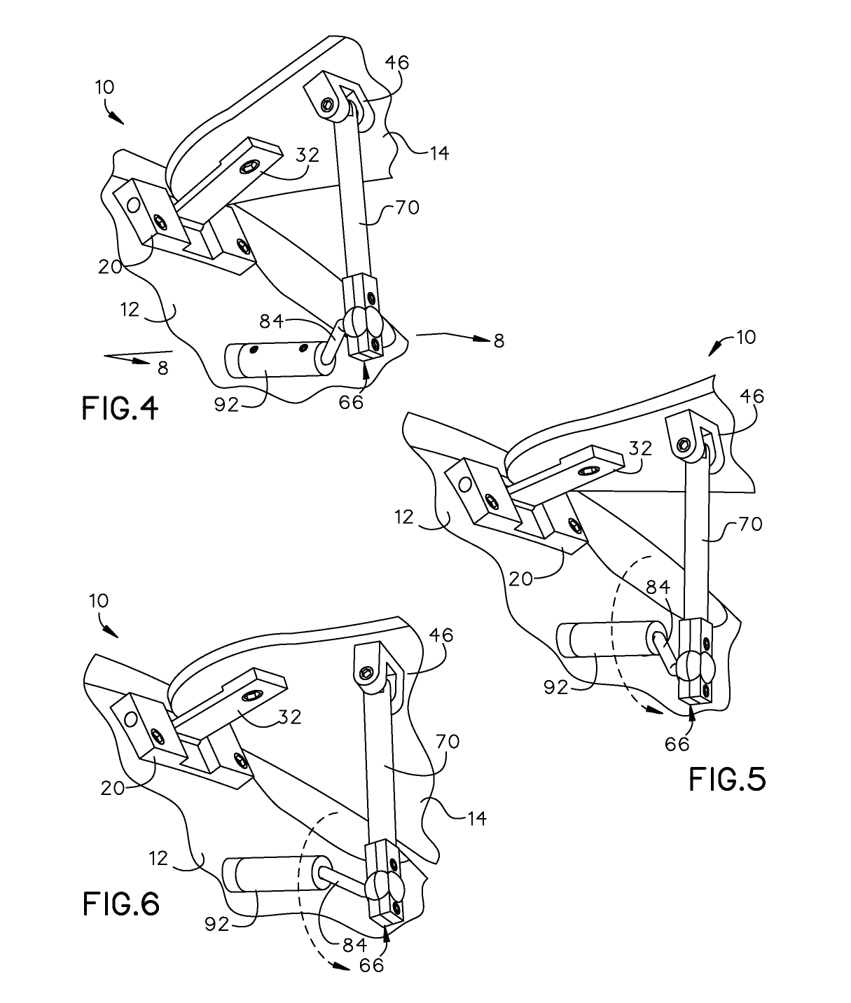

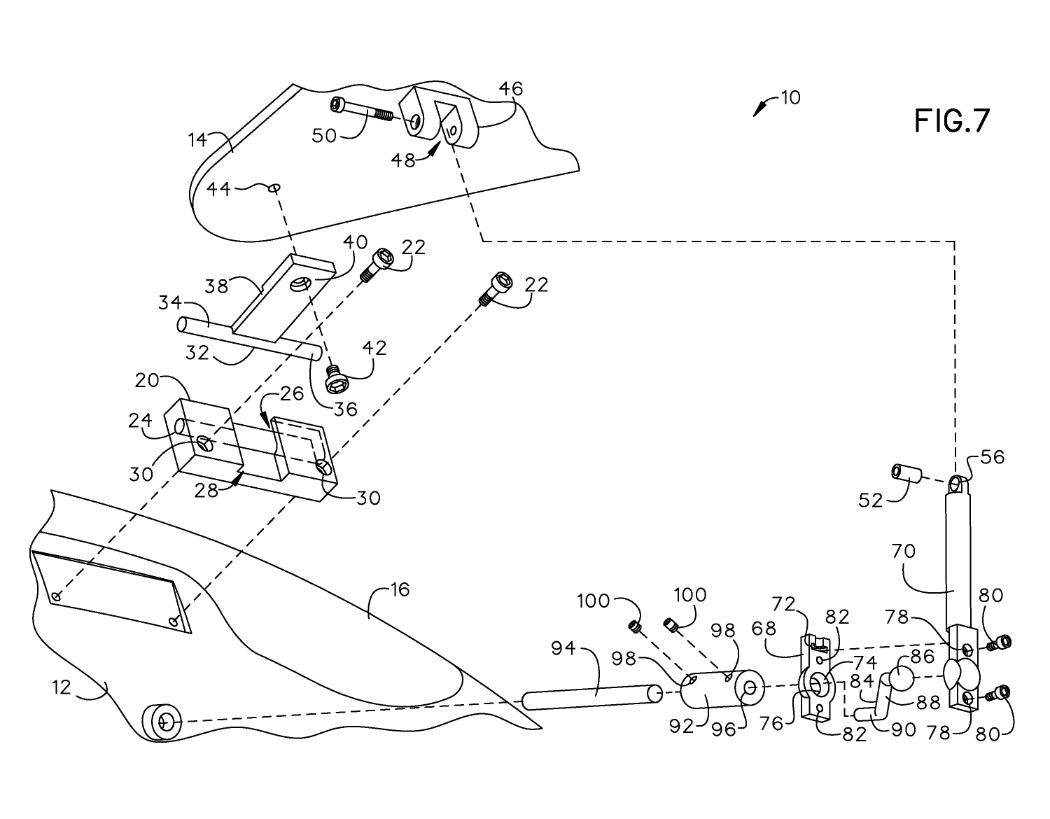

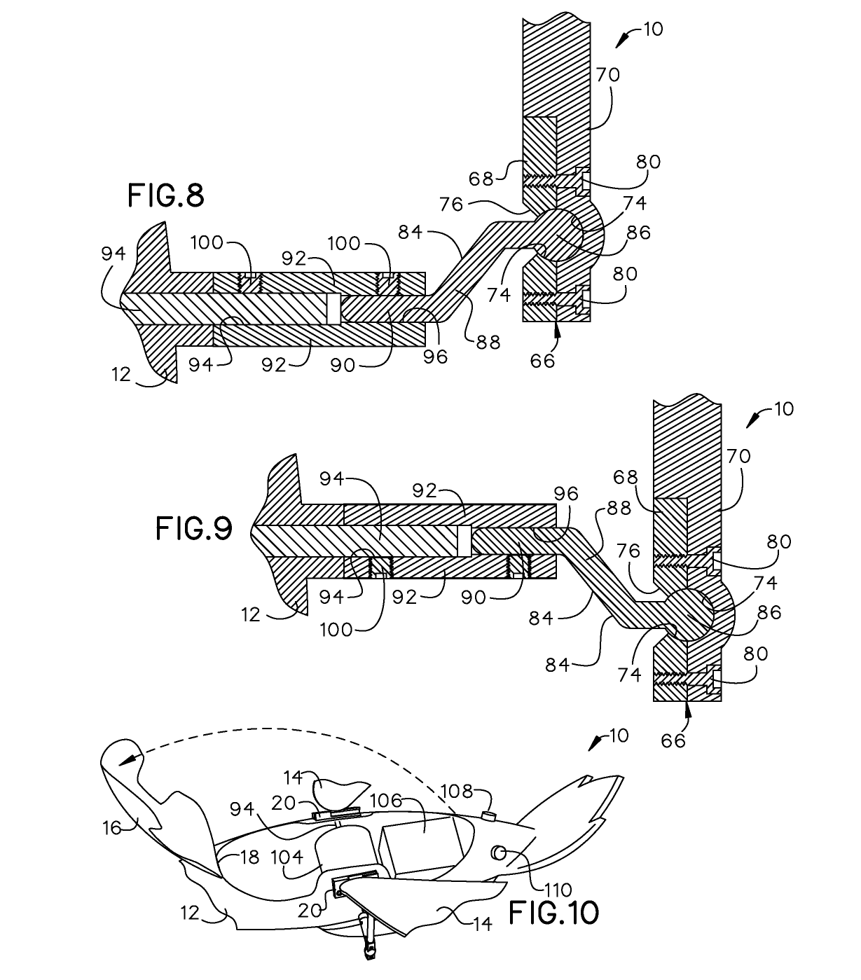

Referring to FIGS. 1 through 10, the present invention includes an actuating duck decoy 10. The duck decoy 10 includes a body 12 in the shape of a duck. The body 12 includes an outer surface with a first side, a second side, a top, a bottom, a front and a rear. The body 12 further includes an internal housing. The present invention further includes a first wing 14 pivotally attached to the first side of the body 12 and a second wing 14 pivotally attached to the second side of the body 12. A motor 104 powered by a power source 106 is housed within the internal housing of the body 12. The motor 104 drives a rotating axle 94. A first actuating bracket 102 connects the bottom of the first wing 14 to the axle 94 and a second actuating bracket 102 connects the bottom of the second wing 14 to the axle 94. The motor 104 and the first and second actuating brackets 102 are operable to pivot the first wing 14 and the second wing 14 along an axis running from the front to the rear of the body 12. Therefore, the motor 104 pivots the wings 14 up and down from the top to the bottom.

Each of the actuating brackets 102 of the present invention may include multiple rotating and pivoting components. As illustrated in the Figures, the actuating bracket may include an angled ball rod 84. The angled ball rod 84 may include a substantial straight first end 90, an angled body 88 and a substantially straight second end with a ball 86 at the second end. The angled ball rod 84 is attached to and rotates with the axle 94. The actuating brackets 102 further include a ball joint coupling assembly 66. The ball joint coupling 66 has an internal cavity 74 in which the ball 86 is disposed and rotates within. A pivot arm 70 may include a top end and a bottom end. The top end is pivotally connected to the bottom of the wing 14 and the bottom end is secured to the ball joint coupling assembly 66. Therefore, when the axle 94 rotates the angled ball rod 84, the angled ball rod 84 may push the pivot arm 70 up and down, thereby pivoting the wings 14 up and down.

In certain embodiments, the angled ball rod 84 is connected to the axle 94 by a rotating coupling 92. The rotating coupling 92 may be a tube with an internal channel 96. A portion of the axle 94 may protrude from the body 12 on either side below the wings 14. The portion of the axle 94 may be inserted into the internal channel 96 of the rotating coupling 92. The substantially straight first end 90 of the angled ball rod 84 may be inserted into the internal channel 96 on the opposite end of the axle 94. The rotating coupling 92 may include holes 98 through the side that intersect with the internal channel 96. Set screws 100 may be secured within the holes 98, thereby securing the portion of the axle 94 and the substantially straight first end 90 within the rotating coupling 92.

In certain embodiments, the ball joint coupling assembly 66 may be made of multiple portions that may be disassembled. For example, the ball joint coupling assembly 66 may include a cover 68. The bottom of the pivot arm 70 may include openings 78 aligning with openings 82 formed in the cover 68. Fasteners 80 may be driven through the aligning openings 78, 82 and thereby securing the cover 68 to the bottom end of the pivot arm 70. The cover 68 and the bottom end of the pivot arm 70 form the cavity 74 when secured together. In such embodiments, the cover 68 may include a tapered opening 76 that leads into the cavity 74. Therefore, the second end of the angled ball rod 84 may run through the tapered opening 76 and the ball 86 is secured within the cavity 74.

The pivot arms 54 may be pivotally attached to the bottom of the wings 14 by a wing pivot bracket 46. The wing pivot bracket 46 is secured to the bottom of the wing 14. The wing pivot bracket 46 may include protrusions forming a channel 48 within. The protrusions may include aligning openings. The top end of the pivot arms 54 may include an opening 56 that aligns with the openings of the protrusions when the top end of the pivot arm 54 is within the channel 48. A pivot pin 50 may run through the openings of the channel 48 and the opening 56 of the pivot arm 54 and thereby pivotally connect the pivot arm 54 with the wing 14. In certain embodiments, a sleeve 52 or bearing may be secured over the pivot pin 50 and within the opening 56 of the pivot arm 54.

The present invention may further include a first hinge assembly 20, 32 pivotally attaching the first wing 14 to the body 12 and a second hinge assembly 20, 32 pivotally attaching the second wing 14 to the body 12. Each of the first hinge assembly 20, 32 and the second hinge assembly 20, 32 includes a mounting bracket 20 and a pivot clip 32. The mounting bracket 20 includes openings 30 aligning with openings on the outer surface of body 12. Fasteners 22 may run through the aligning openings 30 and secure the mounting bracket 20 to the body 12. The mounting bracket 20 may include a stem slot 24 formed within and an arm slot 28 substantially perpendicular to the stem slot 24. The pivot clip 32 may include a stem 34 and an arm 38 extending substantially perpendicular from the stem 34. The arm 28 includes an opening 40 aligning with an opening 44 in the wing 15. A fastener 42 may run through the aligning openings 40, 44, thereby securing the arm 28 to the wing 14. The stem 34 fits and pivots within the stem slot 34, thereby pivotally connecting the body 12 to the wing 14.

The power source of the present invention may be a battery 106. The battery 106 may be within the internal housing and may be electrically connected to the motor 104. In certain embodiments, the present invention may include a power switch 108 which may turn the motor on and off. Further, the present invention may include a speed control switch 110 which may be used to change the speed of the rotation of the axle 94 and therefore control the speed of the up and down motion of the wings 14.

In certain embodiments, an opening may be formed on the body 12 that leads into the internal housing. In such embodiments, the present invention may include a lid 16 releasably attachable to the body 12 and covering the opening leading to the internal cavity. The opening may be formed on the top of the body 12 in between the wings 14. In certain embodiments, the lid 16 is pivotally attached to the body 12 by a hinge 18 and is secured in a closed position by a latch. Therefore, if the user needs to repair or replace the motor 104 or battery 106, the user may open the lid and access the internal components with ease.

In operation, the motor 104 may be turned on by the power switch 18. The motor may turn the axle 94, which thereby rotates the angled ball rod 84. The angled ball rod 84 may move the pivot arm 54 up and down due to the angled body 88. The pivot arm 54 may move the wings 14 up and down simulating a duck flapping its wings.

It should be understood, of course, that the foregoing relates to exemplary embodiments of the invention and that modifications may be made without departing from the spirit and scope of the invention as set forth in the following claims.

What is claimed is:

1. An actuating duck decoy comprising:
a body in the shape of a duck comprising an outer surface comprising a first side, a second side, a top, a bottom, a front and a rear, and an internal housing;
a first wing pivotally attached to the first side of the body and a second wing pivotally attached to the second side of the body;
a motor comprising a power source, wherein the motor is within the internal housing and comprises a rotating axle; and
a first actuating bracket connecting the first wing to the axle, and a second actuating bracket connecting the second wing to the axle, wherein the motor and the first and second actuating brackets are operable to pivot the first wing and the second wing along an axis running from the front to the rear of the body.

2. The actuating duck decoy of claim 1, wherein each of the first and second actuating brackets comprise:
an angled ball rod comprising a ball, wherein the angled ball rod is rotated by the axle;
a ball joint coupling assembly comprising a cavity, wherein the ball is disposed within the cavity; and
a pivot arm comprising a top end and a bottom end, wherein the top end is pivotally connected to a bottom of the wing and the bottom end is attached to the ball joint coupling assembly.

3. The actuating duck decoy of claim 2, further comprising a rotating coupling securing each of the angled ball rods to the axle, wherein the rotating coupling comprises an internal channel, wherein the angled ball rod and the axle are fixedly secured within the internal channel.

4. The actuating duck decoy of claim 3, wherein the ball joint coupling a cover secured to a bottom end of the pivot arm by fasteners and forming the cavity when secured together, wherein the cover comprises a tapered opening leading into the cavity.

5. The actuating duck decoy of claim 2, further comprising a wing pivot bracket secured to each of the first wing and second wing, wherein the pivot arms are pivotally attached to the wing pivot brackets by a pivot pin through aligning openings of the wing pivot bracket and the top end of the pivot arm.

6. The actuating duck decoy of claim 1, further comprising a first hinge assembly pivotally attaching the first wing to the body and a second hinge assembly pivotally attaching the second wing to the body.

7. The actuating duck decoy of claim 6, wherein each of the first hinge assembly and second hinge assembly comprise:
a mounting bracket fastened to the body, and comprising a stem slot formed within, and an arm slot substantially perpendicular to the stem slot; and
a pivot clip comprising a stem within the stem slot of the mounting bracket and an arm fastened to the wing, wherein the arm pivots within the arm slot.

8. The actuating duck decoy of claim 1, wherein the power source is a battery within the internal housing.

9. The actuating duck decoy of claim 1, further comprising at least one of a power switch and a speed control switch operatively connected to the motor.

10. The actuating duck decoy of claim 1, further comprising a lid releasably attachable to the body and covering an opening leading to the internal cavity.

11. The actuating duck decoy of claim 10, wherein the lid is pivotally attached to the body by a hinge and is secured in a closed position by a latch.
